(19) United States
(12) Patent Application Publication
(10) Pub. No.: US 2026/0322282 A1
(43) Pub. Date: Oct. 15, 2026

(54) FRACTIONAL POWER DIRECT CURRENT CHARGING SYSTEMS AND CONTROL METHODS THEREOF

(71) Applicant: Deere & Company, Moline, IL (US)

(72) Inventor: Brij N. SINGH, West Fargo, ND (US)

(73) Assignee: Deere & Company, Moline, IL (US)

(21) Appl. No.: 18/872,209

(22) PCT Filed: Nov. 24, 2023
(86) PCT No.: PCT/US2023/081033

§ 371 Date: Dec. 5, 2024

Related U.S. Application Data
(60) Provisional application No. 63/385,487, filed on Nov. 30, 2022.

(51) Int. Cl. H02M 3/335; B60L 53/62; H02M 1/00; H02M 1/14

(52) U.S. Cl. CPC H02M 3/33573; B60L 53/62; H02M 1/0067; H02M 1/14; H02M 3/33576; B60L 2210/10

(57) ABSTRACT

According to one or more example embodiments, a charging system includes a voltage converter configured to receive a varying voltage from a voltage source and convert the varying voltage into a first direct current (DC) voltage, the first DC voltage having a first ripple; and a DC-DC conversion system configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple, the DC-DC conversion system including at least one DC-DC converter.

### CROSS-REFERENCE TO RELATED APPLICATIONS

This application claims priority under 35 U.S.C. § 119 (e) to U.S. Provisional Appln. No. 63/385,487 filed on Nov. 30, 2022, the entire contents of which are hereby incorporated by reference.

### FIELD

Example embodiments are related to fractional power direct current (DC) charging systems and methods thereof.

### SUMMARY

As electric vehicles become more common, particularly with respect to agricultural machines, charging systems for these vehicles are needed. Moreover, fast charging is also needed to reduce the time it takes to charge the vehicles and well as increased mobility to charge these vehicles. Mobile chargers mitigate and eliminate runtime/charge anxiety of operators, resulting in accelerated adoption of all electric vehicles (EVs) in construction and agriculture applications.

According to one or more example embodiments, a charging system includes a voltage converter configured to receive a varying voltage from a voltage source and convert the varying voltage into a first direct current (DC) voltage, the first DC voltage having a first ripple; and a DC-DC conversion system configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple, the DC-DC conversion system including at least one DC-DC converter.

According to one or more example embodiments, a charging system includes a voltage converter configured to receive a varying voltage from a voltage source and convert the varying voltage into a first direct current (DC) voltage, the first DC voltage having a first ripple; a DC-DC converter configured to receive the first DC voltage and generate a second DC voltage based on the first DC voltage; and a transformer configured to generate an injected voltage and a load voltage for charging a load based on the first DC voltage and the second DC voltage, the injected voltage having an injection ripple, the load voltage having a reduced ripple compared to the first ripple and the injection ripple.

According to one or more example embodiments, a charging system includes a voltage converter configured to receive a varying voltage from a voltage source and convert the varying voltage into a first direct current (DC) voltage, the first DC voltage having a first ripple; and a plurality of DC-DC converters configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple.

### BRIEF DESCRIPTION OF THE DRAWINGS

Example embodiments will be more clearly understood from the following detailed description taken in conjunction with the accompanying drawings. FIGS. 1-8 represent non-limiting, example embodiments as described herein.

FIG. 1A illustrates a single-phase AC to DC charging system according to one or more example embodiments;

FIG. 1B illustrates a DC-DC converter of the conversion system of FIG. 1A according to one or more example embodiments;

FIG. 2A illustrates a three-phase AC to DC charging system according to one or more example embodiments;

FIG. 2B illustrates a DC-DC converter of the conversion system of FIG. 2A according to one or more example embodiments;

FIG. 3A illustrates a charging system according to one or more example embodiments;

FIG. 3B illustrates a charging system according to one or more example embodiments;

FIG. 4A illustrates a charging system for a three-phase voltage source according to one or more example embodiments;

FIG. 4B illustrates a charging system for a three-phase voltage source according to one or more example embodiments;

FIG. 5 illustrates a fractional charging system according to one or more example embodiments;

FIG. 6 illustrates another charging system according to one or more example embodiments;

FIG. 7 illustrates another charging system according to one or more example embodiments; and

FIG. 8 illustrates a power supply system according to one or more example embodiments.

### DETAILED DESCRIPTION

Some example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware.

Such existing hardware (e.g., data processors and controllers) may be implemented using processing or control circuitry such as, but not limited to, one or more processors, one or more Central Processing Units (CPUs), one or more microcontrollers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits.

Further, at least one embodiment of the invention relates to a non-transitory computer-readable storage medium comprising electronically readable control information stored thereon, configured such that when the storage medium is used in a controller of a DC-DC converter, at least one embodiment of the method is carried out.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory, tangible computer readable medium is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects.

The term memory is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways. The term data storage device may be used interchangeably with computer-readable medium.

Many remote agriculture and construction sites do not have access to an electric grid beyond 110V and/or 480V. The non-availability of high-voltage grid in remote locations coupled with impracticality of driving an off-road EVs to charging stations makes use of stationary fast charger difficult. These aspects manifest an impediment in adoption of heavy-duty off-road EVs. However, some of these remote sites are likely to get solar and wind generation systems in future, which will serve as an encouragement factor for early adopters of EVs in agriculture and construction operations. However, to accelerate adoption of EVs in agriculture and construction operations, these EVs should have access to a suitable charger, such as a mobile charger. Also, charge dispensation by a mobile fast charger to the EVs in agriculture and construction sites is desirable as these vehicles will lose productivity and undesirably suffer from downtime if driven to a remote charging station, which is at best likely to be connected with a weak electric grid or may not be available, when needed the most.

Moreover, standards may require that the charging requires a stable DC voltage. Conventionally, this has been difficult if using a varying voltage input source. The inventors have discovered systems for stabilizing a DC voltage and AC rectified voltage, therefore, invention can stabilize varying voltage input sources, which may be used to charge a load (e.g., a battery of an EV).

At least some example embodiments provide, a mobile fast charge delivery system for the remotely located EVs used in farming and construction operations. A suitable ruggedized 700V/600 kW mobile fast charger for off-road vehicle applications is not readily commercially available on the market in the U.S.

At least some example embodiments allow for vehicles reductions in greenhouse gas (GHG) and criteria pollutant emissions compared to vehicles designed with the power shift transmission using an internal combustion engine-based powertrain.

Farm and/or construction sites jobs are often time sensitive as these jobs are completed by continuous operation of the off-road EVs. Therefore, it is highly desired to eliminate or minimize downtime of these EVs. Example embodiments use fractional-power fast charging to reduce vehicle downtime. EVs could also be an on-road EV needing a rapid replenishment of the battery SOC.

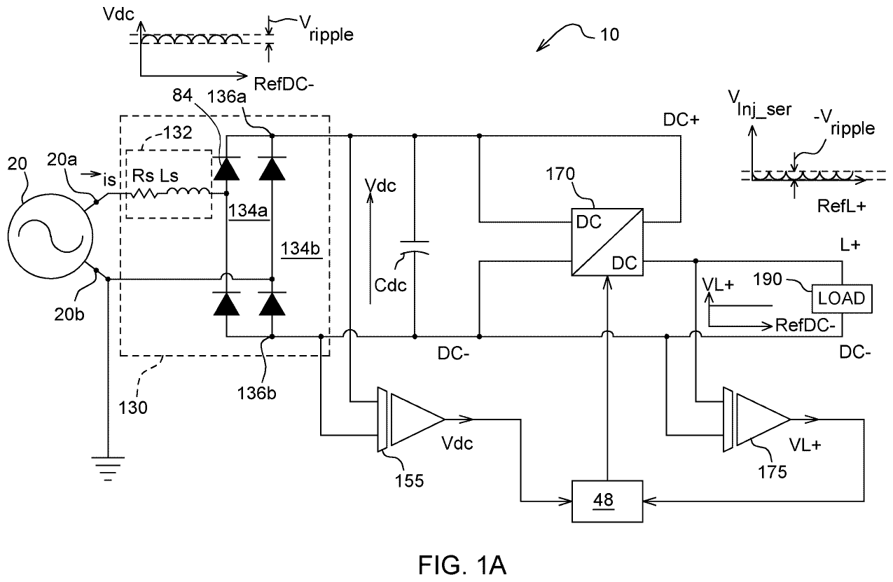

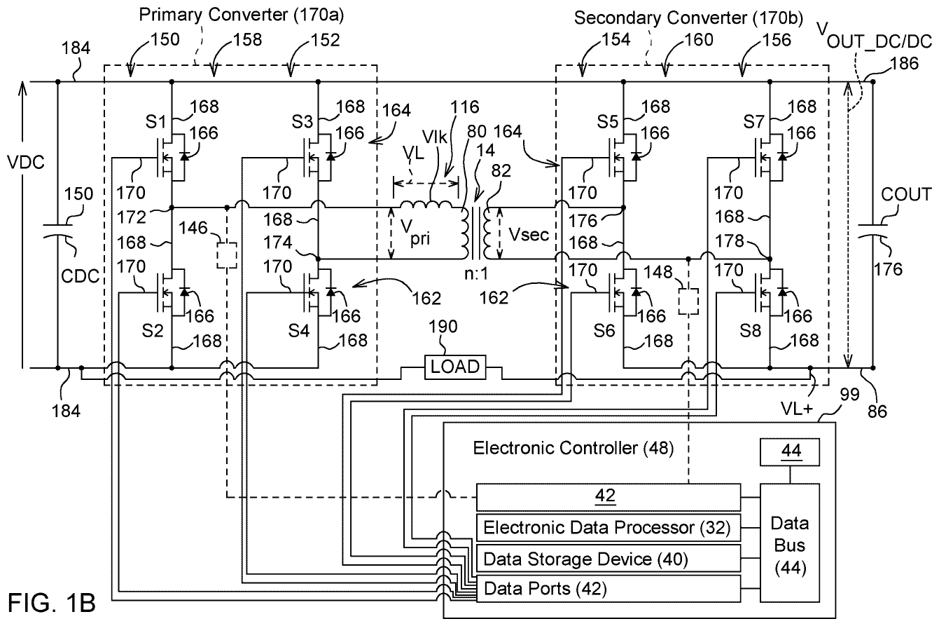

FIG. 1A illustrates a single-phase AC to DC conversion system according to one or more example embodiments. A charging system 10 is configured to convert an AC voltage into a DC voltage, stabilize the DC voltage and output the stabilized voltage to a load, e.g., for charging.

The charging system 10 includes a single-phase AC-DC converter 130, a DC capacitor (DC link) 150, a controller 48 (shown in FIG. 1B) and a power conversion system 170. In some example embodiments, the power conversion system 170 may be a single-phase DC-DC converter. The charging system 10 may be connected to a single-phase AC voltage source 20 at an input side and may be connected to a load 190 at an output side.

The single-phase AC voltage source 20 may be a single-phase AC generator and have a frequency of 40-600 Hz and a voltage of 60-150 V. In some example embodiments, the single-phase AC voltage source 20 is a mobile charger. Some other examples of the AC voltage source include an electrical outlet, a switched reluctance generator and a generator on an aircraft. While example embodiments are described herein with reference to an AC source, it should be understood that example embodiments may be implemented using a DC generator.

The load 190 may be a battery of an EV. In other example embodiments, the load 190 may be a super/ultra capacitor. In other example embodiments, the load 190 may be an electrolyzer which produces hydrogen and electrical energy can be converted into hydrogen energy.

As shown in FIG. 1A, the AC voltage source 20 is coupled to the AC-DC converter 130. A RL 132, between the AC voltage source 20 and the AC-DC converter 130 represents a stray parameter associated with the AC voltage source 20, stray resistance (e.g., in milli ohms) and inductance (e.g., in micro henry), respectively. The RL 132 is represented by a resistor Rs and an inductor Ls.

In some example embodiments, an LCL filter may be used between the AC voltage source 20 and the AC-DC converter 130.

The AC-DC converter 130 may be an uncontrolled rectifier and includes half-bridges 134a and 134b. Each half-bridge includes two diodes 84 that are placed across the DC-link 150.

One diode 84 in each half-bridge is a top-side of the half-bridge and the other diode 84 is a low side of the half-bridge.

Although diodes are shown, it should be understood that an inverter instead of a converter may be used that includes switch packages such as transistors (e.g., MOSFET, field effect, complementary metal oxide semiconductors, power transistors, or other suitable semiconductor devices) coupled in parallel with diodes may be used to convert AC voltage to DC voltage. If uncontrolled rectifier 130 is replaced with an inverter (AC to DC power converter), an LCL filter may be used between the voltage source and the inverter, where the value of R and L may be similar to the stray resistance and inductance and C (capacitance) can be a few nano Farad to tens of micro-Farads.

As used in this document, switch states indicate whether a properly functioning or unimpaired semiconductor device is active (“on” or “closed”) or inactive (“off” or “open”). A failure of a semiconductor device to change states may result in a semiconductor device failing in an open state or a closed state, for example.

A first end of the resistor Rs is connected to a first terminal 20a of the voltage source 20 and a second end of the resistor Rs is connected to a first end of the inductor Ls. A second end of the inductor Ls is connected between the diodes 84 of the half-bridge 134a (i.e., between a cathode of a low side diode 84 and an anode of a high side diode 84). A second terminal 20b of the voltage source 20 is connected between the diodes 84 of the half-bridge 134b (i.e., between a cathode of a low side diode 84 and an anode of a high side diode 84).

The converter 130 converts the voltage of the voltage source 20 into a DC voltage V_{dc} (e.g., a first DC voltage) across output terminals 136a and 136b of the converter 130 and outputs the DC voltage V_{dc} to the DC-link 150.

The DC-link 150 may have a rating, for example, 200V (for 120V single-phase AC supply at input), and a capacitance C_{dc} determined based on the converter design and applications' requirements. In at least one example, the capacitance C_{dc} can be ~250V rated with 100 μF to 1000 μF for a 10 kW system DC supply system with 120V single-phase AC source at its input.

The charging system 10 may further include a voltage sensor 155 to sense the voltage V_{dc} output from the converter 130.

While a DC voltage with little to no ripples is desired, the voltage V_{dc} output by the converter 130 has a ripple (pulsates) at two times the frequency of the single-phase voltage source 20 (i.e., a second harmonic-based ripple). The ripple of the voltage V_{dc} is shown as Vᵣᵢₚₚₗₑ (e.g., a first ripple). The ripples are inherent to the nature of the converter 130. If a large capacitor is connected to make the DC link 150, then pulsation/ripples can be eliminated or minimized to be negligibly a small value but a large capacitor connected across the DC link 150 will result in input current is to have an unwanted peak and distortion. Moreover, such a large capacitor may be costly and will lower reliability of the innovative charger.

Due to the second harmonic-based ripple, the voltage V_{dc} may not be a desirable voltage source to charge the load 190.

The DC-DC converter 170 generates a voltage V_{Out_DC/DC} to reduce/cancel out the second harmonic-based ripple of the voltage V_{dc} and, as a result, provide a more stable voltage V_{L+} for the load 190.

The voltage Ref_{DC-} refers to using a negative bus line DC− as a voltage reference point.

FIG. 1B illustrates the DC-DC converter 170 of the charging system 10 according to one or more example embodiments.

The DC-DC converter 170 includes a primary converter 170a and a secondary converter 170b.

The primary converter 170a comprises a first pair 150 of primary switches and a second pair 152 of primary switches coupled between direct current input terminals 84 of the primary converter 170a which are the terminals of the DC-link 150.

The secondary converter 170b comprises a first pair 154 of secondary switches and second pair 156 of secondary switches coupled between direct current output terminals 186 of the secondary converter.

A transformer 114 is coupled between the primary converter 170a and the secondary converter 170b. A primary winding 180 of the transformer 114 is coupled to output terminals of the first pair 150 and second pair 152 of primary switches and a secondary winding 182 of the transformer 114 is coupled to output terminals of the secondary switches 160.

In one configuration, an electronic data processor 32 or electronic controller 48 is configured to adjust or maintain a modulation frequency (e.g., pulse width modulation (PWM)) of the primary converter 170a and the secondary converter 170b.

To cancel/reduce the ripple in the rectified AC (60 Hz in US outlets, 400 Hz in aircraft) voltage, the DC/DC converter 170 produces an anti-ripple voltage (e.g., a second ripple shown as −Vᵣᵢₚₚₗₑ in FIG. 1A), since it is a control system to provide anti-ripple voltage to cancel ripple in the AC rectified voltage. In the example embodiment shown in FIG. 1A, the voltage produced by switching the switches of the DC/DC converter 170 at greater than 20 times of the frequency of the AC voltage source 20 produces a desired shape for the anti-ripple voltage Vᵣᵢₚₚₗₑ that cancels out/reduces the ripple of the voltage in the output of the rectifier 130.

The primary converter 170a may include a full bridge having a first pair 150 of primary switches and a second pair 152 of primary switches. The first pair 150 of primary switches is coupled between direct current (DC) primary terminals 84 (e.g., input terminals) of the primary converter 170a; the second pair 152 of primary switches 158 is coupled between DC primary terminals 84 (e.g., input terminals) primary converter 170a. The first pair 152 and second pair 158 of primary switches may be referred to as an H-bridge.

In one embodiment, the DC-to-DC converter 170 comprises a single phase, dual-active bridge DC-to-DC converter with DC primary terminals 184 (e.g., DC input terminals) at the primary full bridge 170b and DC secondary terminals 186 (e.g., DC output terminals) at the secondary full bridge 170b.

Each pair of primary switches 158 comprises a low-side switch 162 and a high-side switch 164. Similarly, each pair of secondary switches 160 comprises a low-side switch 162 and a high-side switch 164. Each switch (158, 160) has switched terminals 168 that are controlled by a control terminal 171. For example, if the switch is a field effect transistor, such as a metal oxide semiconductor field effect transistor (MOSFET) (e.g., Silicon Carbide MOSFET), the switched terminals 168 comprise a source and drain terminal and the control terminal 171 comprises a gate terminal. In one configuration, for each pair of primary switches 158, the switched terminals 168 of the low-side switch 162 are coupled in series to the switched terminals 168 of the high-side switch 164 between the DC primary terminals 184.

As illustrated in FIG. 1B, each switch has a protective diode 166 coupled in parallel to the switched terminals 168 of the respective switch. In one embodiment, the switches (158, 160) may comprise silicon carbide field effect transistors or other wide-band-gap semiconductor devices.

In the primary converter 170a, the switched terminals 168 of the first pair 150 of the low-side switch 162 and the high-side switch 164 are coupled together at a first node 172 or first junction associated with a primary alternating current signal. In the primary converter 170a, the switched terminals 168 of the second pair 152 of the low-side switch 162 and the high-side switch 164 are coupled together at a second node 174 or second junction associated with the primary alternating current signal.

A secondary full bridge 170b comprises a third pair 154 of switches (e.g., secondary switches 160) and a fourth pair 156 of switches (e.g., secondary switches 160) coupled between DC secondary terminals 186 (e.g., output terminals) of the secondary converter 170b. The third pair 154 of switches (e.g., secondary switches 160) is coupled between direct current secondary terminals (e.g., output terminals) of the converter 170b; the fourth pair 156 of switches (e.g., secondary switches 160) is coupled between DC secondary terminals 186 (e.g., output terminals) of the secondary converter 170b.

Each pair of secondary switches 160 comprises a low-side switch 162 and a high side switch 164. Each secondary switch 160 has switched terminals 168 that are controlled by a control terminal 170. For example, if the switch is a field effect transistor, such as a metal oxide semiconductor field effect transistor (MOSFET) (e.g., silicon carbide MOSFET devices), the switched terminals 168 comprise a source and drain terminal and the control terminal 170 comprises a gate terminal. As illustrated in FIG. 1B, each secondary switch 160 has a protective diode 166 coupled in parallel to the switched terminals 168 of the respective switch.

In the DC-to-DC converter 170 in one illustrative configuration, each diode 166 facilitates current dissipation associated with the respective switch (158, 160), to which the diode 166 is coupled in parallel, to reduce transient voltages across the switch (e.g., during a prior turn-off, prior deactivation or prior dead-time of the switch in preparation) for the next turning on of the switch, or next activating of the switch (158, 160). In one embodiment, the protective diodes 166 may be composed gallium nitride diodes or other semiconductor materials.

In the secondary converter 170b, the switched terminals 168 of the third pair 154 of low-side switch 162 and the high-side switch 164 are coupled together at a third node 176 or third junction associated with a secondary alternating current signal. In the secondary converter 170b, the switched terminals 168 of the fourth pair 156 of low-side switch 162 and the high-side switch 164 are coupled together at a fourth node 178 or fourth junction associated with the secondary alternating current signal.

In one embodiment, a transformer 114 is coupled between the primary converter 170a and the secondary converter 170b. For example, a primary winding 180 of the transformer 114 is coupled to a first node 172 (e.g., first output terminal) of the first pair 150 and the second node 174 (e.g., second output terminal) of second pair 152 of primary switches 158. Similarly, a secondary winding 182 of the transformer 114 is coupled to a third node 176 (e.g., third output terminal) of the third pair 154 and a fourth node 178 (e.g., fourth output terminal) of the fourth pair 156 of switches (e.g., secondary switches 160).

The transformer 114 has at least one primary winding 180 and at least one secondary winding 182, where a transformer 114 ratio (n) represents a voltage ratio between the primary terminals and the secondary terminals, or between the primary winding and the secondary winding. For example, the primary winding 180 ratio may represent the number of relative turns (n) of the primary winding 180 to the secondary winding 182. The voltage ratio or winding ratio (turn ratio) may depend upon the winding configuration, the conductor configuration, and the configuration of any core, such as ferromagnetic core, a ferrite core, or an iron core.

In one embodiment, an inductor or variable inductor 116 is coupled in series with the primary winding 180 of the transformer. In an alternate embodiment, the variable inductor is associated with a set of discrete inductors that can be connected, via a set of switches, in series, in a parallel, or both, to achieve an adjustable aggregate inductance. For example, the controller 48 or the data processor 32 can control or adjust the variable inductor, or its associated switches, to tune the transformer 114 for the target modulation frequency (e.g., of a pulse width modulation (PWM) signal) to minimize power loss, power difference or thermal dissipation of the converter 170.

The DC-link 150 (e.g., battery, capacitor, or generator output) is coupled to the direct current (DC) primary terminals 184 (e.g., input terminals).

An output capacitor 176 (e.g., active or passive load) is configured to be coupled to the direct current (DC) secondary terminals 186 (e.g., output terminals). As shown the voltage V_{Out_DC/DC} is output across the secondary terminals 186. As shown in FIG. 1A, the voltage V_{Out_DC/DC} has a ripple that reduces/cancels out the second harmonic-based ripple of the voltage V_{dc}. More specifically, in some example embodiments, the voltage V_{Out_DC/DC} is realized by switching the DC/DC converter 170 at greater than 20 times the frequency of voltage source 20 and to generate the voltage V_{Out_DC/DC} such that it has a same ripple frequency of the voltage V_{dc}.

The voltage V_{dc} has a ripple which has pulsating effects at twice the frequency of the AC voltage source 20. The voltage V_{Out_DC/DC}, produced by the converter 170, has a ripple frequency the same as the ripple of the voltage V_{dc} but opposing the ripple of the voltage V_{dc} (i.e., the ripple of the same absolute magnitude, but the ripple of V_{dc} is positive and the ripple of V_{Out_DC/DC} is negative such that a voltage V_{L+} (e.g., a load voltage) has a reduced ripple and/or cancelled out ripple) and the voltage V_{Out_DC/DC} is realized by switching the switches of the DC/DC converter 170 at greater than 20 times the frequency of AC voltage source.

A link 188 connects the secondary converter 170b to the primary converter 170a such that the primary converter 170a and the secondary converter 170b are not isolated from each other. The load 190 is connected between a low side input terminal 84 and a low side output terminal 86. As shown in FIG. 1A, the voltage V_{L+} across the load 190 has a reduced or no ripple as DC/DC converter 170 is controlled to cancel out the ripple in V_{dc} in such a way that the voltage V_{L+} is a more stable voltage for the load 190 and can be used for charging.

In certain embodiments, the DC primary terminals 184 are configured to operate at a different voltage level than the DC secondary terminals 186. In other embodiments, the DC primary terminals 184, the DC secondary voltage levels can have variable voltage levels that can fluctuate with the load 190 or operating conditions on a dynamic basis for each time interval (e.g., sampling time of DC voltage observed at the DC primary input and DC secondary output terminals of the converter). For example, the DC primary terminals 184 operate at a higher voltage level or higher voltage range (e.g., approximately 2×VDC to approximately 3×VDC) than a lower voltage level or lower voltage range of (e.g., approximately 1.25×VDC to approximately 1.5×VDC) the DC secondary terminals 186.

In some example embodiments, the primary converter 170a has a voltage rating of 1.5× of the voltage V_{dc} and the secondary converter 170b has a rating of 0.2 s the voltage V_{dc}.

In one embodiment, the electronic controller 48, is configured to provide time-synchronized control signals to the control terminals 170 of the primary switches 158 and secondary switches 160 to control the converter 170 to operate efficiently in a phase-shift mode (a first mode), a triangular waveform control mode (a second mode) and a trapezoidal waveform control mode (a third mode).

In one embodiment, the electronic controller 48 comprises an electronic data processor 32, a data storage device 40, and one or more data ports 42 coupled to or in communication with a data bus 44. The electronic data processor 32, the data storage device 40, and one or more data ports 42 may communicate data messages between each other via the data bus 44.

The electronic data processor 32 comprises a microcontroller, a microprocessor, a programmable logic array, a logic device, an arithmetic logic unit, a digital signal processor, an application specific integrated circuit or another device for processing or manipulating data. The data storage device 40 comprises electronic memory, nonvolatile random-access memory, magnetic storage device, an optical storage device, or another device for storing, retrieving and managing data, files, data structures or data records. The data ports 42 may comprise an input/output port, a data transceiver, a wireline transceiver, a wireless transceiver, buffer memory, or a combination of the foregoing items.

In one embodiment, the electronic data processor 32 or its data ports 42 are connected to or in communication with the control terminals 170 of the switches (e.g., primary switches 158 and the secondary switches 160) of the primary converter 170a and the secondary converter 170b. Accordingly, the electronic controller 48 can control the timing and operation of each switch, such as activation time, deactivation time, biasing and other aspects. In one embodiment, the electronic controller 48 or electronic data processor 32 uses a fixed switching frequency of fundamental frequency (e.g., within an operational range of switching frequencies) of the switches for multiple or all modulation modes, such as the first mode, the second mode and the third mode. Further, the switches can operate with a same or substantially similar fixed duty cycle (e.g., 50 percent duty cycle plus or minus ten percent tolerance) for multiple or all modulation modes, such as the first mode, the second mode and the third mode. In some configurations, the peak magnitude and duration of the gate signal of the high-side switch 164 and low-side switch 162 of any pair or phase will generally be equal or substantially equivalent.

Although the DC primary terminals 184 (e.g., DC primary bus) and the DC secondary terminals 186 (e.g., DC secondary bus) have fixed voltage levels, the primary voltage (Vₚᵣᵢ) at (or across) the transformer primary winding 180, or the secondary voltage (V_{sec}) at (or across) the transformer secondary winding 182 or both can vary. The voltage V_{sec} produced by the DC/DC converter 170 is controlled by the controller 48 as it forms voltage V_{Out_DC/DC} (e.g., a second DC voltage), which cancels the ripple in the voltage Vdc.

Referring back to FIG. 1A, the first voltage sensor 155 and the second voltage sensor 175 are configured to: (a) measure the voltage V_{dc} at the DC primary input terminals 184 and the load voltage V_{L+}, and (b) provide the measurements to the electronic controller 48 via one or more data ports 42.

In one embodiment, a first voltage sensor 146 (e.g., primary voltage sensor) is configured to measure the primary voltage (e.g., root-mean-squared voltage, peak voltage or other alternating current voltage measurement) and a second voltage sensor 148 (e.g., secondary voltage sensor) is configured to: (a) measure the observed primary and secondary voltages (e.g., root-mean-squared voltage, peak voltage or other alternating current voltage measurement) and (b) provide the measurements observed voltage readings of the primary voltage and secondary voltage (e.g., at the transformer terminals of the primary winding and secondary winding) to the electronic controller 48 via one or more data ports 42. In another embodiment, the first voltage sensor 146 and the second voltage sensor 148 may measure one or more of the following: alternating current (AC) voltage levels, root-mean-squared (RMS) voltage levels, or rectified alternating current (e.g., via a half-wave or full-wave bridge rectifier) at one or more transformer windings (180, 182). Further, the electronic controller 48 or electronic data processor 32 is configured to estimate the DC primary voltage at the DC primary input terminals 184 and the DC secondary voltage at the DC secondary output terminals 186 of the converter 170 based on the measurements, or can control the switches in an initialization mode or test mode to facilitate direct measurement of the primary voltage at the DC primary input terminals 184 and the secondary voltage at the DC secondary output terminals 186 of the converter.

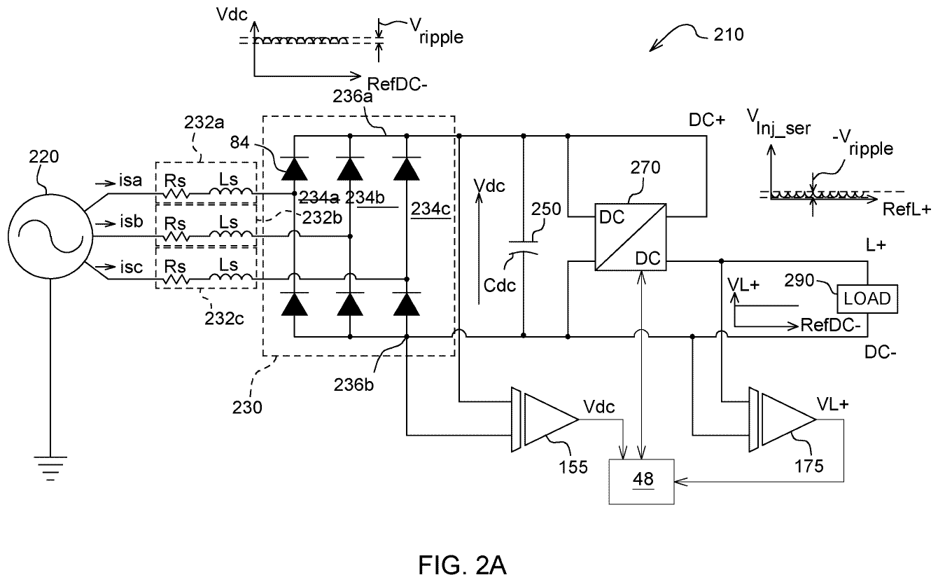

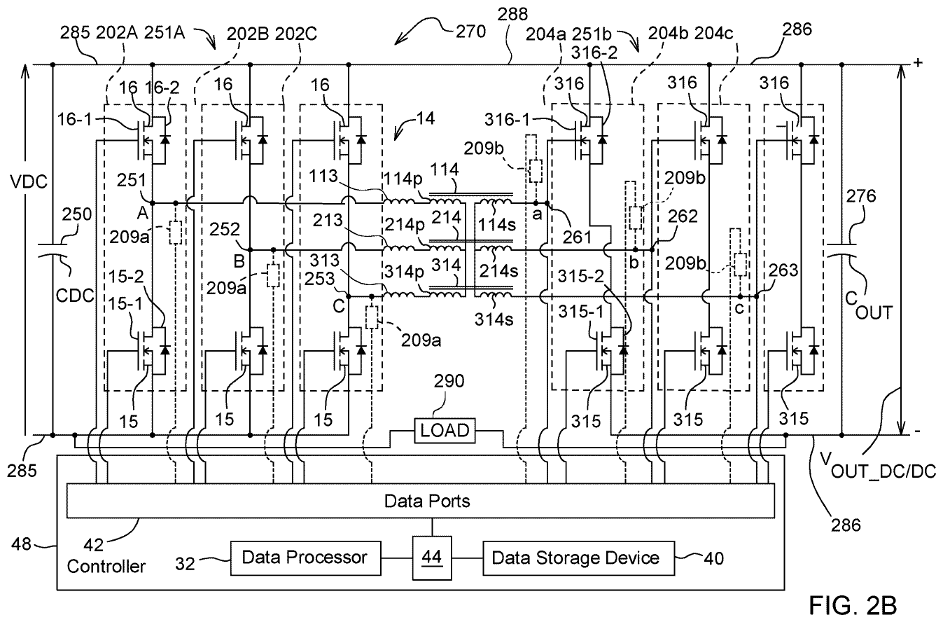

FIG. 2A illustrates a three-phase AC to DC conversion system according to one or more example embodiments.

A charging system 210 is configured to convert a three phase AC voltage into a DC voltage, stabilize the DC voltage and output the stabilized voltage to a load, e.g., for charging.

The charging system 210 includes a three phase AC-DC converter 230, a DC capacitor (DC link) 250, a controller 48 and a power conversion system 270. In some example embodiments, the power conversion system 270 is a three-phase DC-DC converter. The charging system 210 may be connected to a three phase AC voltage source 220 at an input side and may be connected to a load 290 at an output side. The three phase AC voltage source 220 produces three phase currents iₛₐ, i_{sb} and i_{sc}.

The three phase AC voltage source 220 may have a frequency of 40-600 Hz and a voltage of 200-480 V. Some examples of the AC voltage source include the power grid. In some example embodiments, the single-phase AC voltage source 220 is a mobile charger. Some other examples of the AC voltage source 220 include a switched reluctance generator and a generator on an aircraft. While example embodiments are described herein with reference to an AC source, it should be understood that example embodiments may be implemented using a DC generator.

The load 290 may be a battery of an EV. In other example embodiments, the load 290 may be a super/ultra capacitor. In other example embodiments, the load 290 may be an electrolyzer which produces hydrogen and electrical energy can be converted into hydrogen energy. The load 290 may have a load power 3 to 5 times greater than the load 190, shown in FIG. 1A.

As shown in FIG. 2A, the AC voltage source 220 is coupled to the AC-DC converter 230 through a stray RL for each phase 232a-232c. Each of the stray RL 232a-232c may include the stray resistance and inductance illustrate as the resistor Rs and the inductor Ls.

In some example embodiments, an LCL filter may be used for each phase between the AC voltage source 220 and the AC-DC converter 230.

The AC-DC converter 230 may be an uncontrolled rectifier and includes half-bridges 234a, 234b and 234c, one for each phase. Each half-bridge includes two diodes 84 that are placed across the DC-link 250.

One diode 84 in each half-bridge is a top-side of the half-bridge and the other diode 84 is a low side of the half-bridge.

Although diodes are shown, it should be understood that an inverter instead of a converter may be used that includes switch packages such as transistors (e.g., MOSFET, field effect, complementary metal oxide semiconductors, power transistors, or other suitable semiconductor devices) coupled in parallel with diodes may be used to convert AC voltage to DC voltage.

For each phase, a first end of the resistor Rs is connected to the voltage source 220 and a second end of the resistor Rs is connected to a first end of the inductor Ls. A second end of the inductor Ls is connected between the diodes 84 of the half-bridge corresponding to the particular phase (e.g., for phase A, between a cathode of a low side diode 84 and an anode of a high side diode 84 of half bride 234a).

The converter 230 converts the three phase voltage of the voltage source 220 into a DC voltage V_{dc} across output terminals 236a and 236b of the converter 230 and outputs the DC voltage V_{dc} to the DC-link 250.

The DC-link 250 may have a rating, for example, 600V to 700V, and a capacitance C_{dc} determined based on the converter design and applications' requirements. In at least one example, the system shown in FIG. 2A is a 50 kW system and the capacitance C_{dc} is 500 μF to 2000 μF fed from a 380V three-phase AC supply.

In at least some example embodiments, the capacitance C_{dc} is reduced compared to convention systems (e.g., only 2% to 5% of conventional capacitance values) because of the use of the controller to generate a ripple to cancel out the ripple in the voltage V_{dc}.

The charging system 210 may further include the voltage sensor 155 to sense the voltage V_{dc} output from the converter 130.

While a DC voltage with little to no ripple is desired, the voltage V_{dc} output by the converter 230 has a ripple at six times the frequency of the three-phase voltage source 220 (e.g., per phase rectified voltage appearing across capacitor 250 has a second harmonic-based ripple and all three phases rectified collectively results in a sixth harmonic-based ripple). For example, if the three-phase voltage source 220 has a frequency of 60 Hz, the ripple frequency occurs at 360 Hz.

Due to the ripple, the voltage V_{dc} may not be a desirable voltage source to charge the load 290.

The DC-DC converter 270 generates a voltage V_{Out_DC/DC} to reduce/cancel out the ripple of the voltage V_{dc} and, as a result, provide a more stable voltage V_{L+} for the load 290.

FIG. 2B illustrates a DC-DC converter of the conversion system of FIG. 2A according to one or more example embodiments.

A DC-DC converter 200 comprises a three phase, dual-active bridge DC-DC converter with DC primary terminals 285 (e.g., DC input terminals) at a primary bridge 251a and DC secondary terminals 286 (e.g., DC output terminals) at a secondary bridge 251b.

As shown in FIG. 2B, the three-phase DC-DC converter 270 includes the primary bridge (or input inverter bridge) 251a and the secondary bridge (or output rectifier bridge) 251b. The primary bridge 251a includes three bridge portions 202A-202C, each of which corresponds to a separate phase and is coupled between direct current input terminals 285 of the primary bridge 251a. Similarly, the secondary bridge 251b includes three bridge portions 204a-204c, each of which corresponds to a separate phase and is coupled between direct current output terminals 286 of the primary bridge 251a.

As should be understood, use of “A”, “B” and “C” in the context of the DC-DC converter correspond to phases in the primary converter and use of “a,” “b” and “c” correspond to phases in the secondary converter. When referring to phases of the DC-DC converter instead of separately the primary converter or the secondary converter, the phases may be referred to as A-a, B-b and C-c.

The alternating current (AC) terminals (A, B, C) of the primary bridge 251a and the secondary AC terminals (a, b, c) of the secondary bridge 251b, respectively, are coupled together with transformers 114, 214 and 314, respectively. In one embodiment, in FIG. 2B the primary winding of each transformer is associated with a respective capacitor (C_{dc}), which is coupled in parallel across the DC-link 250. Meanwhile, the secondary winding is associated with a respective capacitor 276 (Cₒᵤₜ), which is coupled in parallel across the secondary DC bus to form the 3-phase DAB DC/DC converter circuit 100.

The transformers 114, 214 and 314 are coupled between the primary bridge 251a and the secondary bridge 251b for the three phases, respectively. A primary winding of the transformer 114 is coupled to an output terminal 251 of the bridge portion 202A and a secondary winding of the transformer 114 is coupled to an output terminal 261 of the bridge portion 204a. A primary winding of the transformer 214 is coupled to an output terminal 252 of the bridge portion 202B and a secondary winding of the transformer 214 is coupled to an output terminal 262 of the bridge portion 204b. Lastly, a primary winding of the transformer 314 is coupled to an output terminal 253 of the bridge portion 202C and a secondary winding of the transformer 314 is coupled to an output terminal 263 of the bridge portion 104c.

An output capacitor 276 (e.g., active or passive load) is configured to be coupled to the direct current (DC) secondary terminals 286 (e.g., output terminals). As shown, the voltage V_{Out_DC/DC} is output across the secondary terminals 286. As shown in FIG. 2A, the voltage V_{Out_DC/DC} has a ripple that reduces/cancels out the ripple (e.g., a second harmonic-based ripple) of the voltage V_{dc}. More specifically, in some example embodiments, the controller 48 controls the switches of the converter 270 at greater than 60 times the frequency of the voltage source 220 to generate the voltage V_{Out_DC/DC} that has switching frequency effect of the 60 times the frequency of voltage source 220 and a same ripple frequency as the ripple of the voltage V_{dc}.

A link 288 connects a positive rail of the secondary converter 251b to a positive rail of the primary converter 251a such that the primary converter 251a and the secondary converter 251b are not isolated from each other. The load 290 is connected between a low side input terminal 284 and a low side output terminal 286. As shown in FIG. 2A, the voltage V_{L+} across the load 290 has a reduced or no ripple as DC/DC converter 270 in FIG. 2A is controlled by the controller 48 to cancel out a ripple in Vdc in such way that the voltage V_{L+} in FIG. 2B is a more stable voltage for the load 290 and can be used for charging.

Each bridge portion 204a-204c of the primary bridge 251a includes a high side switch package and a low side switch package that are placed across the DC-link 250. Each switch package includes a diode and a MOSFET transistor. For example, the bridge portion 202A includes a high side switch package 16 and a low side switch package 15. The upper switch package 16 includes a MOSFET 16-1 and a diode 16-2. The lower switch package 15 similarly has a MOSFET 15-1 and a diode 15-2.

Each bridge portion of the secondary bridge 251b includes a high side switch package and a low side switch package that are placed across the capacitor 276. Each switch package includes a diode and a MOSFET transistor. For example, the bridge portion 1204a includes a high side package 316 and a low side package 315. The high side switch package 316 includes a MOSFET 316-1 and a diode 316-2. The low side switch package 315 similarly has a MOSFET 315-1 and a diode 315-2.

When the appropriate voltage is applied to the gate of an MOSFET transistor in a high side or low side switch package, the transistor may be activated and the drain may be coupled electrically to the emitter to supply electric power. The appropriate voltage depends on a rating of the transistor.

Although MOSFET transistors are shown, field effect transistors, complementary metal oxide semiconductors, power transistors, or other suitable semiconductor devices may be used.

In one configuration, for each pair of switch packages in each bridge portion 202A-202C, the switched terminals of the transistor 15-1 of the low side switch package 15 are coupled in series to the switched terminals of the transistor 16-1 of the high side switch package 16 between the DC primary terminals 285. As illustrated in FIG. 2B, each switch package has a diode coupled in parallel to the switched terminals of the respective switch package.

For each pair of switch packages in each bridge portion 204a-204c, the switched terminals of the transistor 315-1 of the low side switch package 315 are coupled in series to the switched terminals of the transistor 316-1 of the high side switch package 316 between the DC secondary terminals 286. As illustrated in FIG. 2B, each switch package has a diode coupled in parallel to the switched terminals of the respective switch package.

In the primary converter 251a, the low side switch package 15 and the high side switch package 16 of the bridge portion 202A are coupled together at a first output terminal 251 or a junction associated with a first phase alternating current signal. The low side switch package 15 and the high side switch package 16 of the bridge portion 202B are coupled together at a second output terminal 252 or a junction associated with a second phase alternating current signal. The low side switch package 15 and the high side switch package 16 of the bridge portion 202C are coupled together at a third output terminal 253 or a junction associated with a third phase alternating current signal.

In the secondary converter 251b, the low side switch package 315 and the high side switch package 316 of the bridge portion 204a are coupled together at a first input terminal 261 or a junction associated with a first phase secondary alternating current signal. The low side switch package 315 and the high side switch package 316 of the bridge portion 204b are coupled together at a second input terminal 262 or a junction associated with a second phase secondary alternating current signal. The low side switch package 315 and the high side switch package 316 of the bridge portion 104c are coupled together at a third input terminal 263 or a junction associated with a third phase secondary alternating current signal.

Each of the transformers 114, 214 and 314 has at least one primary winding (114p, 214p, 314p) and at least one secondary winding (114s, 214s, 314s), where a transformer ratio (n) represents a voltage ratio between the primary terminals and the secondary terminals, or between the primary winding and the secondary winding. For example, the primary winding ratio may represent the number of relative turns of the primary winding to the secondary winding. The voltage ratio or winding ratio (turn ratio) may depend upon the winding configuration, the conductor configuration, and the configuration of any core, such as ferromagnetic core, a ferrite core, or an iron core. Each of the transformers 114, 214 and 314 may have the same turn ratio n.

In one embodiment, inductors or variable inductors 113, 213, 313 are coupled in series with the primary windings of the transformers 114, 214, 314, respectively. The transformers 114, 214 and 314 may be referred to as a three-phase transformer. In an alternate embodiment, the variable inductor is associated with a set of discrete inductors that can be connected, via a set of switches, in series, in a parallel, or both, to achieve an adjustable aggregate inductance. For example, the controller 48 or data processor 32 can control or adjust the variable inductor, or its associated switches, to tune the transformers 114, 214 and 314 for the target modulation frequency (e.g., of a pulse width modulation (PWM) signal) to minimize power loss, power difference or thermal dissipation of the converter 100.

The DC primary terminals 285 are configured to operate at a different voltage level than the DC secondary terminals 286. In other embodiments, the DC primary terminals 285, the DC secondary voltage levels can have variable voltage levels that can fluctuate with the load 290 or operating conditions on a dynamic basis for each time interval (e.g., sampling time of DC voltage observed at the DC primary input and DC secondary output terminals of the converter). For example, the DC primary terminals 285 operate at a higher voltage level or higher voltage range (e.g., approximately 2×VDC to approximately 3×VDC) than a lower voltage level or lower voltage range (e.g., approximately 1.25×VDC to approximately 1.5×VDC) the DC secondary terminals 286.

In some example embodiments, the primary converter 270a has a voltage rating of 1.5× of the voltage V_{dc} and the secondary converter 270b has a rating of 0.2 s the voltage Vac.

In one embodiment, an electronic controller 48, is configured to provide time-synchronized control signals to the control terminals (e.g., gates) of the primary switches 15-1, 16-1, 315-1 and 316-1 to control the converter 270.

A controller 48 may have gate drivers 44, a microprocessor 32 coupled electrically to the gate drivers 44, and a data storage device memory 46 coupled electrically to the microprocessor 32 and having stored therein operating instructions for the microprocessor 32.

The gate driver 44 provides control signals to control terminals (e.g., gate or base). The gate of each transistor 15-1, 16-1, 315-1 and 316-1 is coupled electrically to a respective gate driver 44 that is dedicated to that transistor 15-1, 16-1, 315-1 and 316-1 and may provide a DC voltage to turn on and off that transistor 15-1, 16-1, 315-1 and 316-1. Thus, there may be a gate driver 44 for each transistor 15-1, 16-1, 315-1 and 316-1. The gate drivers 44 are under the control of the processor 32, which may employ a pulse-width-modulation (PWM) control scheme to control those gate drivers 44 and the transistors 15-1, 16-1, 315-1 and 316-1. Switching of transistors 15-1, 16-1, 315-1 and 316-1 results in DC-DC converter 270 to supply electric energy to the load 290 by withdrawing electric energy from the DC-link 250.

The data storage device 40 comprises electronic memory, nonvolatile random-access memory, magnetic storage device, an optical storage device, or another device for storing, retrieving and managing data, files, data structures or data records. The data storage device 40 further stores instructions for the processor 32 to perform the functions described herein.

The converter 270 may include voltage sensors that are isolated devices that sense a high voltage DC bus and the power converter's mid-point output. These voltages are sensed with respect to negative DC bus of the power converter and send a voltage converted to 0V to 5V. Where 0V indicates that sensed high voltage is at 0V and 5V indicates that the sensed high voltage is at its typical value, e.g., 700V. A voltage sensor(s) 209a may measure voltages V_{AN}, V_{BN} and V_{CN}. Similarly, a voltage sensor(s) 209b may measure voltages Vₐₙ, V_{bn} and V_{cn}.

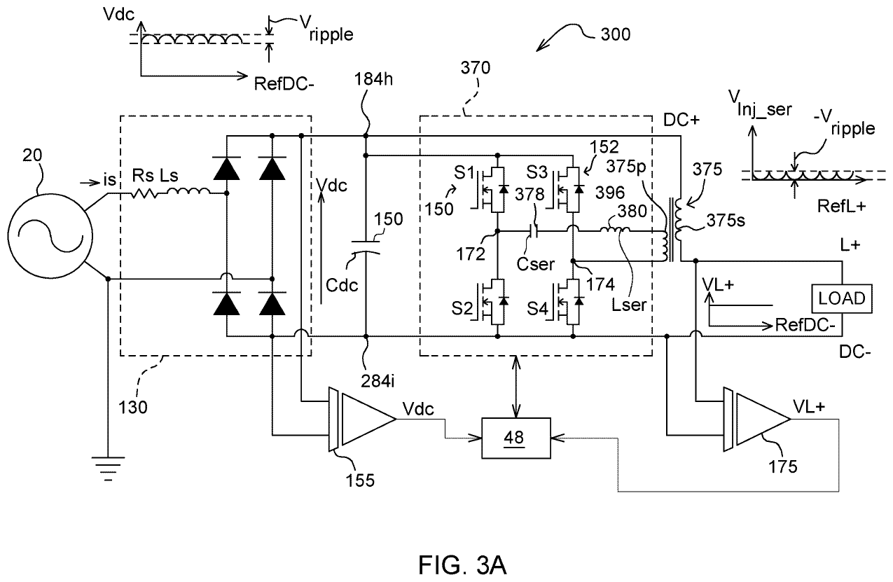

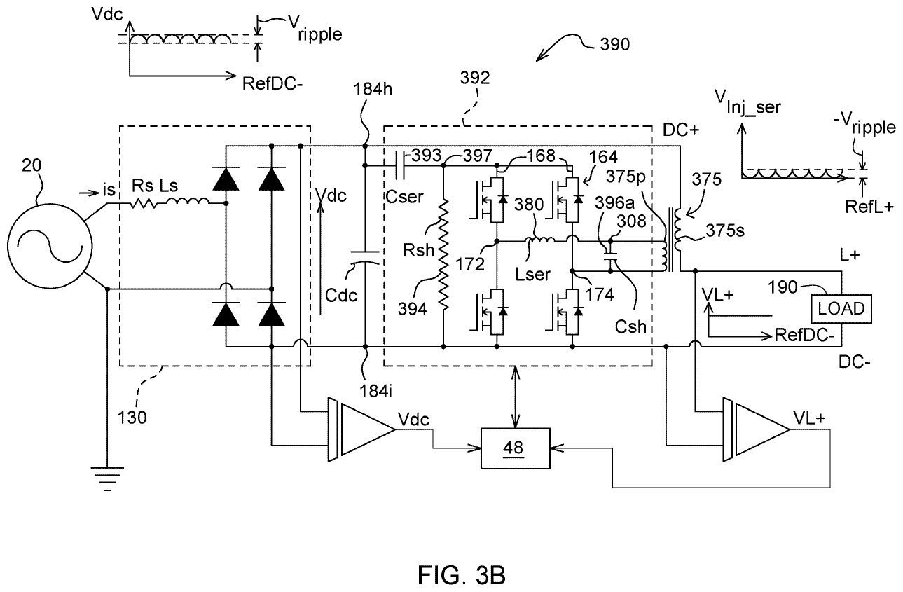

FIG. 3A illustrates a charging system according to one or more example embodiments. As shown in FIG. 3A, a charging system 300 includes an AC-DC converter and a power conversion system 370. In some example embodiments, the power conversion system 370 may be a DC-AC converter. The charging system 300 uses the DC-AC converter 370 and transformer 375 instead of the DC-DC converter 170. Therefore, only the differences between the system 100 and the system 300 will be described.

The DC-AC converter 370 converts the voltage V_{dc} to an AC voltage. The structure of the converter 370 is the same as the primary converter 170a except the DC-AC converter includes a series capacitor 378 (Cₛₑᵣ) having a first end connected to the first node 172 and a second end connected to a first end of a series inductor 380 (Lₛₑᵣ). The series capacitor 378 removes/reduces DC offset current so the transformer 375 does not become saturated and only ripple voltage is imposed across transformer winding 375p.

A primary winding 375p of the transformer 375 is coupled to output terminals of the first pair 150 (via the series capacitor 378 and the series inductor 380) and second pair 152 of primary switches and a secondary winding 375s of the transformer 375 is connected between the DC+ bus of the uncontrolled rectifier 230, which is also terminal 184h of the converter 370 and to the L+ end of load 190.

The load 190 is coupled between the secondary winding 375s and the low side input terminal 184l of the converter 370.

The primary winding 375p becomes a voltage source and the secondary winding 375s provides an injected voltage V_{inj_ser} such that the load voltage V_{L+} provided to the load is sufficiently stable and free from a ripple (or substantially free), resulting in appropriate charging of the load 190.

As shown in FIG. 3A, the injected voltage V_{inj_ser} has a ripple that reduces/cancels out the ripple of the voltage V_{dc} to generate the load voltage V_{L+}. In some example embodiments, the controller 48 controls the switches of the converter 370 at greater than 20 times the frequency of the voltage source 20 to generate the voltage V_{inj_ser} that has switching effects at 20 times the frequency of voltage source 20 and a same ripple frequency as the ripple of the voltage V_{dc} (e.g., a ripple frequency of 120 Hz).

Moreover, the connection between the secondary winding 375s and the converter 370 can be a wire and, thus, does not use the capacitor Cₒᵤₜ (in FIG. 1B).

FIG. 3B illustrates a charging system according to one or more example embodiments. As shown in FIG. 3B, a charging system 390 includes an AC-DC converter and a power conversion system 392. In some example embodiments, the power conversion system 392 may be a DC-AC converter. The charging system 390 uses the DC-AC converter 392 and the transformer 375 instead of the DC-DC converter 170 of FIG. 1A. Therefore, only the differences between the system 100 and the system 390 will be described.

The DC-AC converter 392 converts the voltage V_{dc} to an AC voltage.

The DC-AC converter includes a series capacitor 393 (Cₛₑᵣ), a shunt resistor 394 (Rₛₕ), the first pair of switches 150, the second pair of switches 152, the series inductor 380 and a shunt capacitor 396 (Cₛₕ). Like the primary converter 170a, the converter 392 includes the first pair 150 and the second pair 152 of switches.

A first end of the series capacitor 393 is coupled to the high side terminal 184 and a second send of the series capacitor is coupled to a node 397. A first end of the shunt resistor 394 and the switched terminals 168 of the high-side switches 164 are also coupled to the node 397.

A second end of the shunt resistor 394 and the switched terminals 168 of the low-side switches 162 are coupled to the low-side terminal 184l. The shunt resistor 394 has a large resistance to maintain a stable voltage input to the pairs of switches 150 and 152.

The series inductor 380 has a first end connected to the first node 172 and a second end connected to a node 398. A first end of the shunt capacitor 396 and the first end of the primary winding 375p are also connected to the node 398. A second end of the shunt capacitor 396 and the primary winding 375p are connected to the node 174.

Because the series capacitor 393 removes the DC component of the voltage V_{dc}, the first pair of switches 150 and the second pair of switches 152 can be low-voltage switches (e.g., less than 0.2× the voltage V_{dc} in FIG. 3B).

The primary winding 375p of the transformer 375 is coupled to output terminals of the first pair 150a (via the series inductor 380) and the second pair 152a of primary switches and the secondary winding 375s of the transformer 375 is connected between the DC+ bus of the uncontrolled rectifier 130, which is also the terminal 184h of the converter 392 and to the L+ end of load 190.

The load 190 is coupled between the secondary winding 375s and the low side input terminal 184l of the converter 370.

The primary winding 375p becomes a voltage source and the secondary winding 375s provides an injected voltage V_{inj_ser} such that the load voltage Vit provided to the load is sufficiently stable and free from a ripple (or substantially free), resulting in appropriate charging of the load 190.

As shown in FIG. 3B, the injected voltage V_{inj_ser} has a ripple that reduces/cancels out the ripple of the voltage V_{dc} to generate the load voltage V_{L+}. In some example embodiments, the controller 48 controls the switches of the converter 370 at greater than 20 times the frequency of the voltage source 20 to generate the voltage V_{inj_ser} that has a same ripple frequency as the ripple of the voltage V_{dc} (e.g., a ripple frequency of 120 Hz).

Moreover, the connection between the secondary winding 375s and the converter 370 can be a wire and, thus, does not use the capacitor Cₒᵤₜ (in FIG. 1B).

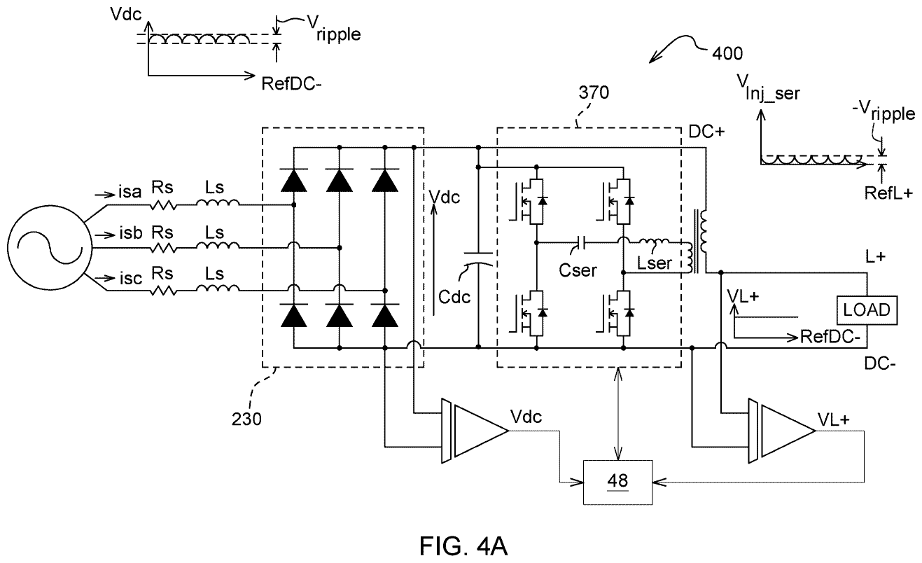

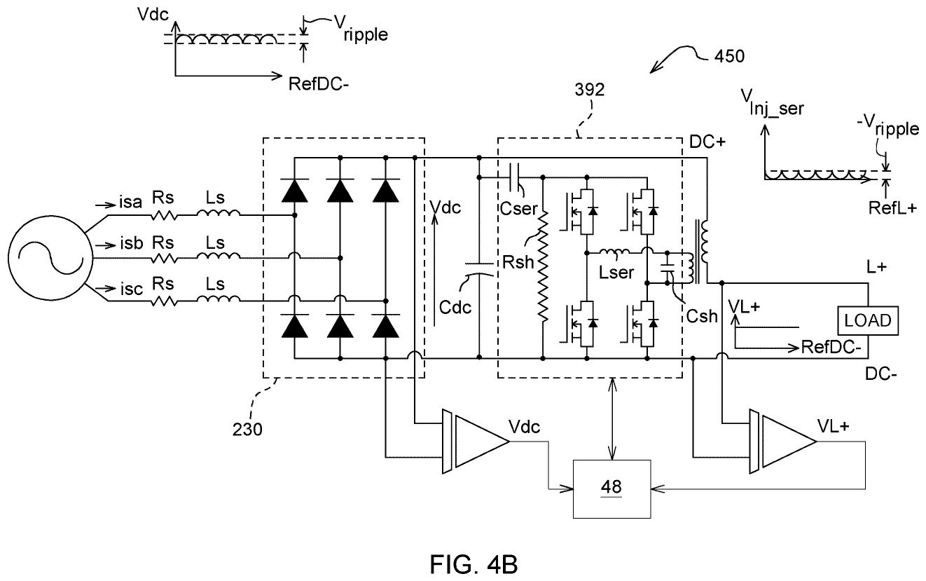

FIG. 4A illustrates a charging system for a three-phase voltage source according to one or more example embodiments. As shown in FIG. 4A, a charging system 400 includes the AC-DC converter 230 and the DC-AC converter 370.

The controller 48 controls the DC-AC converter 400 in FIG. 4A in a similar manner as in FIG. 3A except the controller 48 controls the DC-AC converter 300 in FIG. 4A at three times the frequency of FIG. 3A (e.g., a higher switching frequency is used for the DC-AC converter in FIG. 4A so that the voltage V_{inj_ser} has a shape to cancel out the ripple in the voltage V_{dc} produced by uncontrolled rectifier 230).

FIG. 4B illustrates a charging system for a three-phase voltage source according to one or more example embodiments. As shown in FIG. 4B, a charging system 450 includes the AC-DC converter 230 and the DC-AC converter 392.

The controller 48 controls the DC-AC converter 450 in FIG. 4B in a similar manner as in FIG. 3B except the controller 48 controls the DC-AC converter 450 in FIG. 4b at three times the frequency of FIG. 3B (e.g., a higher switching frequency is used for the DC-AC converter in FIG. 4B so that the voltage V_{inj_ser} has a shape to cancel out the ripple in the voltage V_{dc} produced by uncontrolled rectifier 230).

In the embodiments shown in FIG. 4A-4B, the controller controls the converters 370 and 392 such that the voltage V_{inj_ser} has a same ripple frequency as the voltage V_{dc}, e.g., 360 Hz.

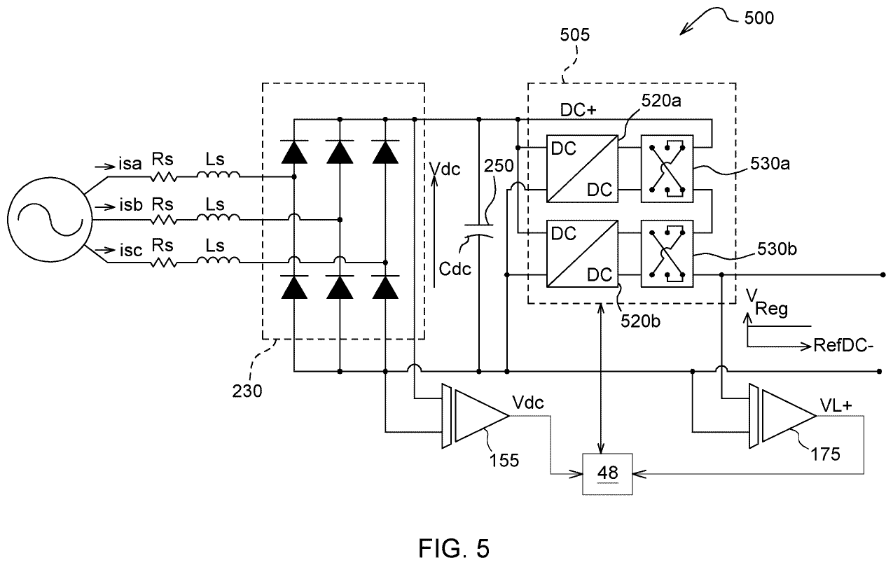

FIG. 5 illustrates a fractional charging system according to one or more example embodiments. A charging system 500 includes the uncontrolled three phase AC-DC converter 230 to generate the voltage V_{dc} across the DC-link 250 and a power conversion system 505 to cancel out/reduce the ripple in the input voltage V_{dc} to generate the regulated voltage V_{Reg}, as shown in FIG. 5.

The power conversion system 505 includes a plurality of DC-DC converters 520a-520b to convert the voltage V_{dc} into a regulated voltage V_{Reg} to feed an energy storage device such as a battery. More specifically, the plurality of DC-DC converters 520a-520b cancel out/reduce the ripple in the input voltage V_{dc} to generate the regulated voltage V_{Reg}, as shown in FIG. 5. Furthermore, each of the DC-DC converters is associated with a polarity switch 530a-530b. The controller 48 is configured to control the DC-DC converters and associated polarity switches 530a-530b to control the polarity of each output of the DC-DC converters 520a-520b (e.g., the controller 48 controls the polarity switch 530 to control the polarity of the output of the DC-DC converter 520a.

In the embodiments shown in FIGS. 3A and 4A, a voltage rating of the converter 370 may be 1.25×Vdc. In the embodiments shown in FIGS. 3B and 4B, a voltage rating of the converter 392 may be <0.25×Vdc.

The use of polarity reversing switches 530a-530b increase the output voltage range of the conversion system 505 to the energy source to be charged.

More specifically, in FIG. 5, the DC-link 250, the DC-DC converter 520a and the DC-DC converter 520b create three voltage sources that are connected in series. Each of the polarity switches 530a, 530b may be controlled such that the voltage output from the respective converter 520a, 520b may be added to or subtracted from the voltage V_{dc}.

In addition, while only two DC-DC converters are shown, any number of DC-converters may be connected as shown with a corresponding polarity switch such that the voltage V_{Reg} may be determined as follows:

$${V}_{Reg} = {V}_{d c} \pm {V}_{out \_ DC / DC 1} \pm {V}_{out \_ DC / D C 2} \pm … \pm {V}_{OutDC / DCn}$$

for n numbers of DC-DC converters connected in series. Therefore, having n number of DC/DC converters along with a polarity reversal switch for each DC/DC converter, the range and granularity in the voltage V_{Reg} can be achieved by the controller appropriately controlling these DC/DC converters.

The DC-DC converters 520a-520b may have the same structure as the DC-DC converter 270 illustrated in FIG. 2B except the low side output terminal of the converter 520a is coupled to a high side output terminal of the converter 520b.

High-efficiency DC fast charging can be carried out using fractional power conversion through control of the DC-DC converters 520a-520b.

The use of multiple DC-DC converters 520a-520b allows the charging system to provide a charging voltage over a large range, e.g., 350V-850V.

While only two DC-DC converters are illustrated, it should be understood that more than two DC-DC converters along with polarity reversal switches may be included to increase the charging range.

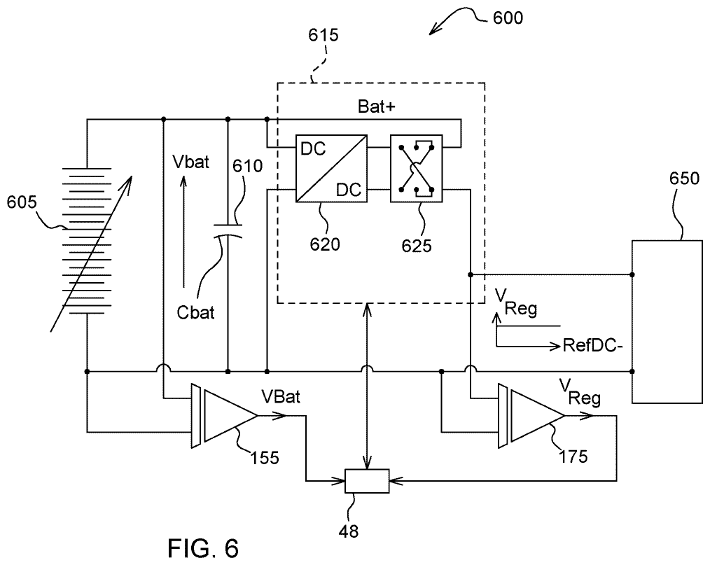

FIG. 6 illustrates another charging system according to one or more example embodiments. A charging system 600 is similar to the charging system 10 except the charging system 600 is configured to be connected to a varying voltage source 605. The varying voltage source 605 may be a battery, for example. In other example embodiments, the varying voltage source 605 can be a variable DC source produced by a DC generator or an AC alternator.

The charging system 600 includes a DC-link 610 (e.g., a capacitor Chat), a power conversion system 615, the controller 48 and voltage sensors 155 and 175. The power conversion system 615 includes a DC-DC converter 620 coupled to a polarity switch 625. The DC-DC converter 620 may be the same as the DC-DC converter 170, shown in FIGS. 1A-1B.

The varying voltage source 605 supplies a DC voltage V_{bat} to the DC-link 610. The DC-link 610 may be a capacitor Chat that has a capacitance between 100 μF to 1000 μF depending upon kWhr rating of battery 605. The voltage sensor 155 measures the varying voltage of the voltage source 605 and the voltage sensor 175 measures the output voltage of the DC-DC converter 620.

The controller 48 is configured to control the DC-DC converter 620 and polarity switch 625 to convert the voltage V_{bat} into a regulated voltage for a load 650. The load may be equipment that requires a constant DC voltage, e.g., a 12V battery in a vehicle. As previously described, the DC-DC converter 620 is configured to remove a ripple (e.g., second harmonic-based ripple) from a voltage input such as the voltage V_{bat} and output a voltage V_{Reg} with a canceled out/reduced ripple for a load. The system shown in FIG. 6 may be used for vehicle to vehicle (V2V) and vehicle to home (V2H) connectively using only fractional power conversion through a single circuit-controlled DC/DC converter.

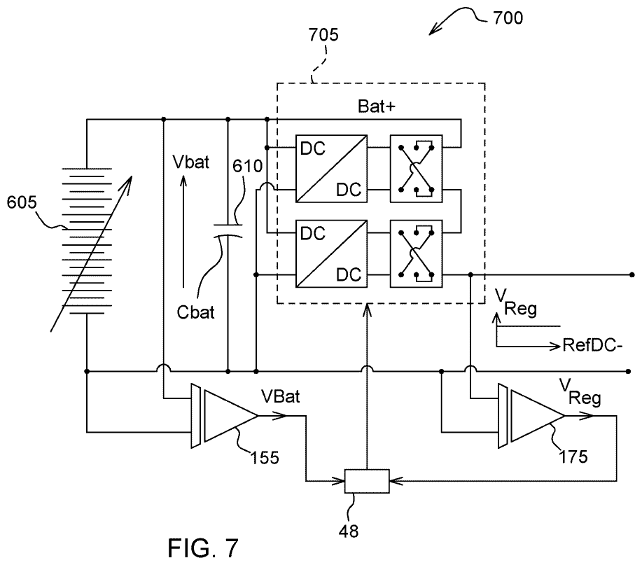

FIG. 7 illustrates another charging system according to one or more example embodiments. A charging system 700 is similar to the charging system 600 except the charging system 700 is configured to be connected to the varying voltage source 605 and the charging system 700 includes a conversion system 705 including DC-DC converters that are single phase converters instead of three phase converters. In some example embodiments, the conversion system 705 can be three-phase converters. When including single-phase converters, the conversion system 705 uses only 0.5% to 1% power to be switched/processed by the DC/DC converters as compared to the total power transferred from source 605 to the load (battery). Thus, the rating of the conversion system 705 doesn't need to be more than 5 kW.

The system shown in FIG. 7 may be used for vehicle to vehicle (V2V) and vehicle to home (V2H) connectively using only fractional power conversion through a single circuit-controlled DC/DC converter.

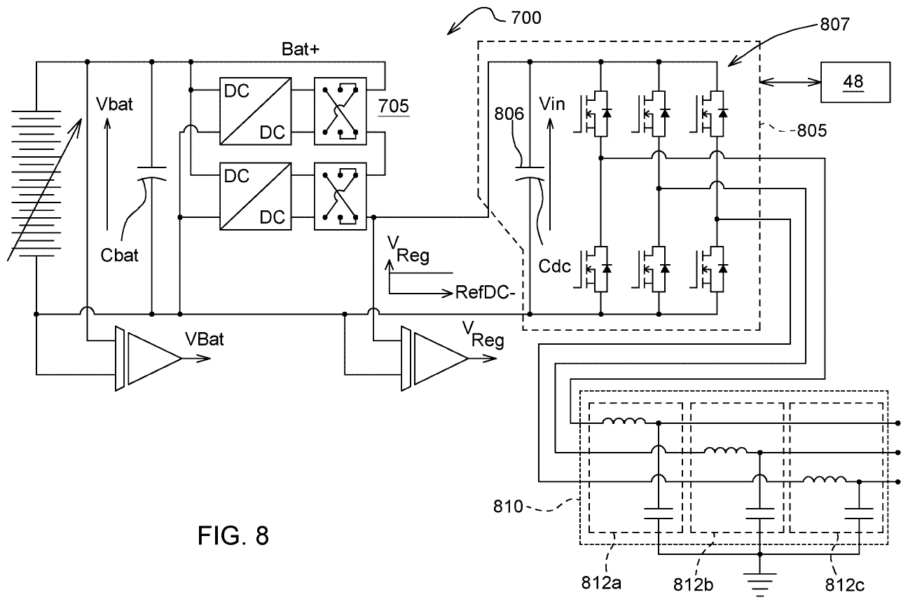

FIG. 8 illustrates a power supply system according to one or more example embodiments. The power supply system includes the charging system 700, a three-phase AC export power system 805 and an output filter 805.

The three-phase AC export power system 805 includes a DC-link 806 and a converter 807. The converter 807 may be the same as the primary converter 251, shown in FIG. 2B, except the power rating of the converter 807 is much higher (e.g., twice as much) than the primary converter 251 in FIG. 2B.

The three-phase AC export power system 805 receives the regulated voltage V_{Reg} from the charging system 700, which is stored across the DC-link 806. The voltage Vᵢₙ is the same as the voltage V_{Reg}. The converter 807 converts the input voltage Vin into a three-phase voltage and delivers the three-phase voltage to the output filter 810. The output filter 810 includes an LC filter 812a-812c for each phase. The output filter 810 filters the three-phase voltage and outputs the filtered three-phase voltage. The filtered three-phase voltage may be output to a load such as a home or an AC load on a tractor requiring clean power.

The systems shown in FIGS. 6-8 illustrate power conversion systems that can be used while a vehicle is driving or stationary. The fraction power conversion permits the DC output (e.g., V_{Reg}) to be industry standards compliant.

As described above, according to one or more example embodiments, a charging system includes a voltage converter configured to receive a varying voltage from a voltage source and convert the varying voltage into a first direct current (DC) voltage, the first DC voltage having a first ripple; and a DC-DC conversion system configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple, the DC-DC conversion system including at least one DC-DC converter.

According to one or more example embodiments, the voltage converter is an uncontrolled rectifier.

According to one or more example embodiments, the at least one DC-DC converter is a single-phase converter.

According to one or more example embodiments, the uncontrolled rectifier is a three-phase rectifier and the at least one DC-DC converter is a three-phase converter.

According to one or more example embodiments, the charging system further includes a controller configured to control the at least one DC-DC converter and cause the at least one DC-DC converter to generate the second DC voltage and the load voltage.

According to one or more example embodiments, the at least one DC-DC converter is dual-active-bridge DC-DC converter.

According to one or more example embodiments, the controller is configured to control a switching frequency for the at least one DC-DC converter to generate the second DC voltage such that the second ripple has a same frequency as a frequency of the first ripple.

According to one or more example embodiments, the controller is configured to control a switching frequency for the at least one DC-DC converter to generate the second DC voltage such that the second ripple has a frequency component of 20 times a frequency of the varying voltage.

According to one or more example embodiments, the controller is configured to control a switching frequency for the at least one DC-DC converter to generate the second DC voltage such that the second ripple has a frequency component of 60 times a frequency of the varying voltage.

According to one or more example embodiments, the voltage converter is configured to generate the first DC voltage such that the first ripple has a frequency component of 2 times a frequency of the varying voltage.

According to one or more example embodiments, the voltage converter is configured to generate the first DC voltage such that the first ripple has a frequency component of 6 times a frequency of the varying voltage.

According to one or more example embodiments, the at least one DC-DC converter is configured to generate the second DC voltage such that the second ripple has a same frequency as a frequency of the first ripple.

According to one or more example embodiments, the at least one DC-DC converter is configured to generate the second DC voltage such that the second ripple has a same magnitude as the first ripple and an opposite polarity of the first ripple.

According to one or more example embodiments, the at least one DC-DC converter includes a primary converter and a secondary converter, a positive rail of the primary converter being directly connect to a positive rail of the secondary converter.

According to one or more example embodiments, the charging system further includes a transformer further coupling the primary converter and the secondary converter.

According to one or more example embodiments, a charging system includes a voltage converter configured to receive a varying voltage from a voltage source and convert the varying voltage into a first direct current (DC) voltage, the first DC voltage having a first ripple; a DC-DC converter configured to receive the first DC voltage and generate a second DC voltage based on the first DC voltage; and a transformer configured to generate an injected voltage and a load voltage for charging a load based on the first DC voltage and the second DC voltage, the injected voltage having an injection ripple, the load voltage having a reduced ripple compared to the first ripple and the injection ripple.

According to one or more example embodiments, the voltage converter is an uncontrolled rectifier.

According to one or more example embodiments, the DC-DC converter is a single-phase converter.

According to one or more example embodiments, the uncontrolled rectifier is a three-phase rectifier and the DC-DC converter is a three-phase converter.

According to one or more example embodiments, the method further includes a controller configured to control the DC-DC converter and cause the DC-DC converter to generate the second DC voltage and cause the transformer to generate the injected voltage and the load voltage.

According to one or more example embodiments, the controller is configured to control the DC-DC converter such that the injected ripple has a same magnitude as the first ripple and an opposite polarity of the first ripple.

According to one or more example embodiments, a charging system includes a voltage converter configured to receive a varying voltage from a voltage source and convert the varying voltage into a first direct current (DC) voltage, the first DC voltage having a first ripple; and a plurality of DC-DC converters configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple.

According to one or more example embodiments, the plurality of DC-DC converters are connected in series.

According to one or more example embodiments, each of the plurality of DC-DC converters is associated with a polarity switch.

According to one or more example embodiments, the charging system further includes a controller configured to control the plurality DC-DC converters and the polarity switches such that a granularity of the voltage conversion is adjustable.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A charging system comprising:
a voltage converter configured to receive a varying voltage from a voltage source and convert the varying voltage into a first direct current (DC) voltage, the first DC voltage having a first ripple; and
a DC-DC conversion system configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple, the DC-DC conversion system including at least one DC-DC converter.

2. The charging system of claim 1, wherein the voltage converter is an uncontrolled rectifier.

3. The charging system of claim 2, wherein the at least one DC-DC converter is a single-phase converter.

4. The charging system of claim 2, wherein the uncontrolled rectifier is a three-phase rectifier and the at least one DC-DC converter is a three-phase converter.

5. The charging system of claim 1, further comprising:
a controller configured to control the at least one DC-DC converter and cause the at least one DC-DC converter to generate the second DC voltage and the load voltage.

6. The charging system of claim 5, wherein the at least one DC-DC converter is dual-active-bridge DC-DC converter.

7. The charging system of claim 5, wherein the controller is configured to control a switching frequency for the at least one DC-DC converter to generate the second DC voltage such that the second ripple has a same frequency as a frequency of the first ripple.

8. The charging system of claim 5, wherein the controller is configured to control a switching frequency for the at least one DC-DC converter to generate the second DC voltage such that the second ripple has a frequency component of 20 times a frequency of the varying voltage.

9. The charging system of claim 5, wherein the controller is configured to control a switching frequency for the at least one DC-DC converter to generate the second DC voltage such that the second ripple has a frequency component of 60 times a frequency of the varying voltage.

10. The charging system of claim 1, wherein the voltage converter is configured to generate the first DC voltage such that the first ripple has a frequency component of 2 times a frequency of the varying voltage.

11. The charging system of claim 1, wherein the voltage converter is configured to generate the first DC voltage such that the first ripple has a frequency component of 6 times a frequency of the varying voltage.

12. The charging system of claim 1, wherein the at least one DC-DC converter is configured to generate the second DC voltage such that the second ripple has a same frequency as a frequency of the first ripple.

13. The charging system of claim 1, wherein the at least one DC-DC converter is configured to generate the second DC voltage such that the second ripple has a same magnitude as the first ripple and an opposite polarity of the first ripple.

14. The charging system of claim 1, wherein the at least one DC-DC converter includes,
a primary converter and a secondary converter, a positive rail of the primary converter being directly connect to a positive rail of the secondary converter.

15. The charging system of claim 14, further comprising:
a transformer further coupling the primary converter and the secondary converter.

16. A charging system comprising:
a voltage converter configured to receive a varying voltage from a voltage source and convert the varying voltage into a first direct current (DC) voltage, the first DC voltage having a first ripple;
a DC-DC converter configured to receive the first DC voltage and generate a second DC voltage based on the first DC voltage; and
a transformer configured to generate an injected voltage and a load voltage for charging a load based on the first DC voltage and the second DC voltage, the injected voltage having an injection ripple, the load voltage having a reduced ripple compared to the first ripple and the injection ripple.

17. The charging system of claim 16, wherein the voltage converter is an uncontrolled rectifier.

18. The charging system of claim 17, wherein the DC-DC converter is a single-phase converter.

19. The charging system of claim 17, wherein the uncontrolled rectifier is a three-phase rectifier and the DC-DC converter is a three-phase converter.

20. The charging system of claim 17, further comprising:
a controller configured to control the DC-DC converter and cause the DC-DC converter to generate the second DC voltage and cause the transformer to generate the injected voltage and the load voltage.

21. The charging system of claim 20, wherein the controller is configured to control the DC-DC converter such that the injected ripple has a same magnitude as the first ripple and an opposite polarity of the first ripple.

22. A charging system comprising:
a voltage converter configured to receive a varying voltage from a voltage source and convert the varying voltage into a first direct current (DC) voltage, the first DC voltage having a first ripple; and
a plurality of DC-DC converters configured to receive the first DC voltage, generate a second DC voltage having a second ripple based on the first DC voltage and generate a load voltage for charging a load based on the first DC voltage and the second DC voltage, the load voltage having a reduced ripple compared to the first ripple and the second ripple.

23. The charging system of claim 22, wherein the plurality of DC-DC converters are connected in series.

24. The charging system of claim 23, wherein each of the plurality of DC-DC converters is associated with a polarity switch.

25. The charging system of claim 24, further comprising:
a controller configured to control the plurality DC-DC converters and the polarity switches such that a granularity of the voltage conversion is adjustable.
